(19) United States
(12) Patent Application Publication
(10) Pub. No.: US 2014/0305375 A1
(43) Pub. Date: Oct. 16, 2014

(54) FEEDER SYSTEM

(71) Applicant: FEEDER TREE, L.L.C., Walker, LA (US)

(72) Inventor: William Eugene Rogillio, Walker, LA (US)

(73) Assignee: FEEDER TREE, L.L.C., Walker, LA (US)

(21) Appl. No.: 13/862,856

(22) Filed: Apr. 15, 2013

(51) Int. Cl. A01K 5/02

(52) U.S. Cl. CPC A01K 5/02
USPC 119/57.91

(57) ABSTRACT

A feeder system comprising a directional automatic feeder; a feed container positioned above the directional automatic feeder; a cavity below the feed container; a structure surrounding the directional automatic feeder, the feed container, and the cavity in which the structure anchored securely to the ground is taught. The use of such feeders is also taught.

A feeder system described herein may, for example, comprise a directional automatic feeder; a feed container positioned above the directional automatic feeder; a cavity below the feed container; a structure surrounding the directional automatic feeder, the feed container, and the cavity; wherein the structure is arranged and configured to be anchored securely to the ground. In a related example, the feeder system may have tension lines arranged and configured to be anchored securely to the ground. In a further related example, the structure comprises fiberglass reinforced concrete. In a further related example, the structure consists essentially of fiberglass reinforced concrete. In a further related example, the structure is camouflaged relative to wooded environments. In a further related example, the structure resembles a tree stump. In a still further related example, the structure resembles a tree stump selected from an oak tree stump, a cypress tree stump, and a pine tree stump. In a further related example, the structure resembles a tree stump selected from a hardwood tree stump and a coniferous tree stump. In a further related example, the structure has a diameter of greater than 24 inches.

### BRIEF DESCRIPTION OF THE DRAWINGS

FIG. 1 is a front view of the feeder system.

FIG. 2 is a rear view of the feeder system.

FIG. 3 is a cut away view of the feeder system.

### DETAILED DESCRIPTION

### Example 1

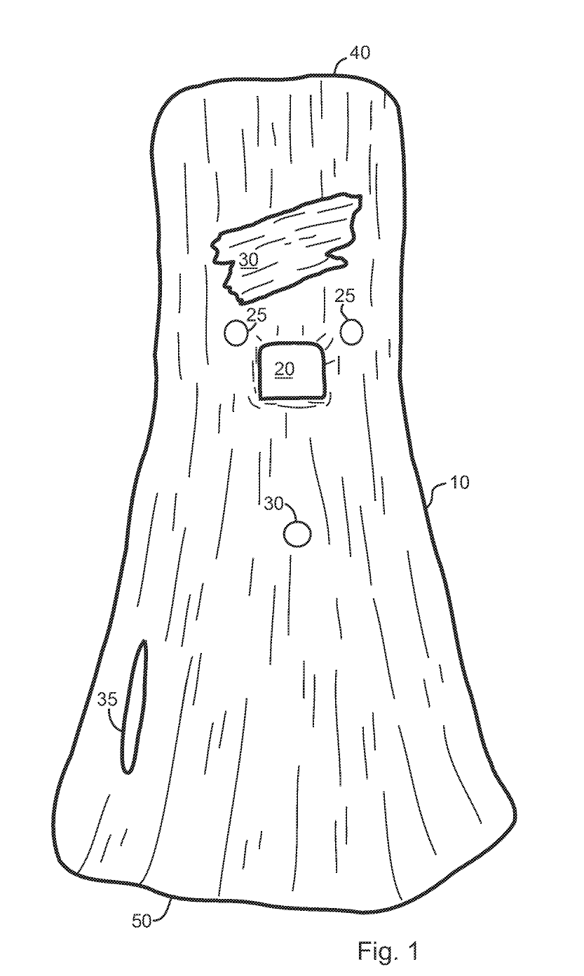

Referring now to FIG. 1 of the drawings, the feeder system comprises Feeder housing 10 which is constructed of a durable weather resistant material such as fiberglass reinforced concrete. Feeder housing 10 may also be constructed of other materials including plastic, epoxy, foam, Poly-paraphenylene terephthalamide, carbon fiber and other materials which are durable and weather resistant. Feeder housing 10 is arranged and configured to surround, conceal, and protect a Feed container 75 (not shown) and an Automatic feeder 90 (not shown). Feeder housing 10 is configured to have the general appearance of a tree stump and may be configured to blend in with natural surroundings like wooded areas. Feed distribution orifice 20 is located at and elevated position on Feeder housing 10. Feed distribution orifice 20 is a size and shape suitable to allow for the effective distribution of an animal feed through the air by Automatic feeder 90. Feed container support bar anchor points 25 indicate positions at which Feeder support bars 80 may be attached on the interior of Feeder housing 10. Message board 30, if present, may indicate through text or other markings, some form of communication such as a trademark of the manufacturer or a message to those that could encounter the feeder system. Knot 35 is an example of one of many potential camouflaging elements that may aid in allowing Feeder housing 10 to blend in to the surroundings. Feeder housing top 40 may be open allowing for easy retrieval and placement of Feeder housing 10. Feeder housing base 50 is in contact with the ground and may optionally be secured tightly to the ground.

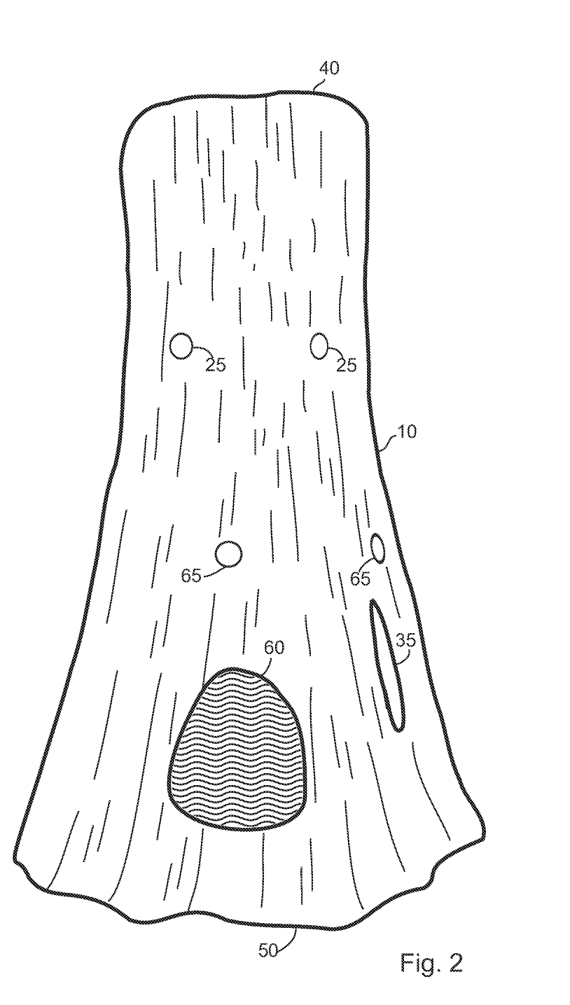

FIG. 2 of the drawings depicts the side of Feeder housing 10 that is opposite the side depicted in FIG. 1. Feed container support bar anchor points 25 are located on the upper portion of Feeder housing 10. Knot 35, Feeder housing top 40, feeder housing base 50, and Feeder housing anchor points 65 are arranged and configured essentially as described in the depiction of FIG. 1. Feeder rear access panel 60 serves as a panel door to access the interior of Feeder housing 10 so that set up, maintenance, and other activities requiring access to the interior of Feeder housing 10 may be accomplished through the opening Feeder rear access panel 60 may also be closed in a secure way that limits undesired access to the interior of Feeder housing 10. Feeder rear access panel 60 may for example be secured by a lock.

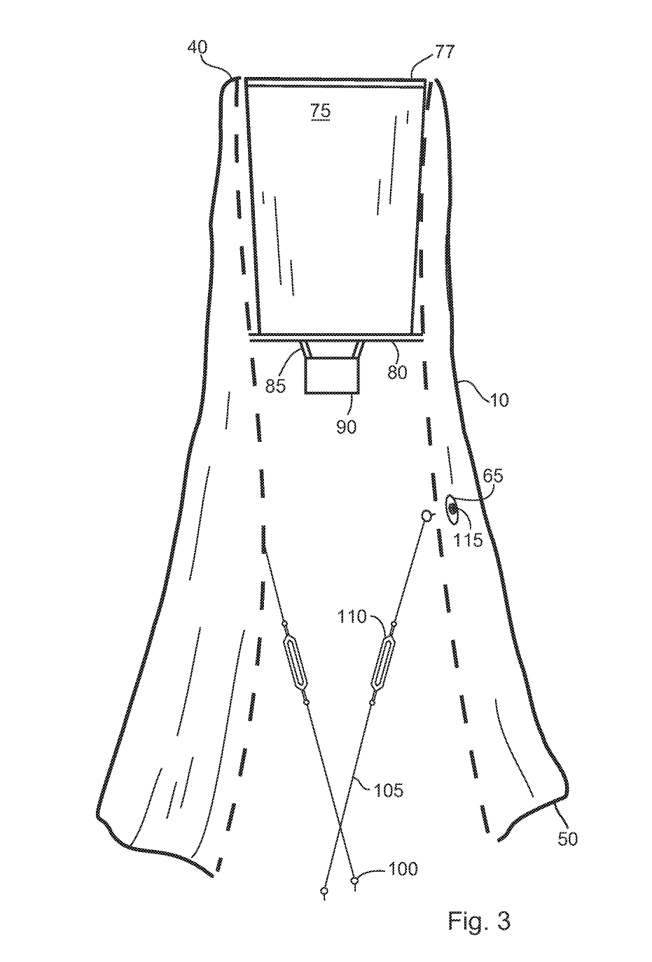

FIG. 3 of the drawings depicts a cut away view of Feeder housing 10. Feeder support bar 80 spans the interior space of Feeder housing 10 and supports the weight of Feed container 75. Automatic feeder connection brackets 85 suspends Automatic feeder 90 below Feed container 75 and position Automatic feeder 90 such that Automatic feeder 90 is positioned to distribute the through Feed distribution orifice 20. Automatic feeder 90 may for example be the Directional Feeder Kit model no. MFHP60059 sold by Moultrie Feeders, 150 Industrial Road Alabaster, Ala. 35007. Ground anchor rods 100 are fixed securely in the ground and may take the form of stakes. Anchoring lines 105 serve to compress Feeder housing base 50 against the ground upon the tensioning of Anchor lines 105 by Anchoring tensioning device 110 which may for example be a turnbuckle. Anchoring line 105 is secured to Feeder housing 10 by Housing anchor bolt 115 at Feeder housing anchor point 65. Feed container 75 is positioned in the upper portion of Feeder housing 10 in a position that may be accessed through the opening at Feeder housing top 40. Feed container 75 typically has a feed container top 77 which protects the feed from the weather. Feed container top 77 may, for example, be secured in place by one or more security measures such as ratcheting straps accessible only from the interior of Feeder housing 10.

Feeder housing 10 is constructed of fiberglass reinforced concrete having a thickness that is sufficient to resist moderate tampering and having a diameter that is narrow enough to place the feeder system on the rack of an all-terrain vehicle. In one example, Feeder housing base 50 has a diameter of less than 40 inches. In a related example, Feeder housing base 50 has a diameter of less than 35 inches. In a further example, Feeder housing base 50 may have a diameter of 31 inches. In a still further related example, Feeder housing base 50 may have a diameter of at least 12 inches. In a still further related example, Feeder housing base 50 may have a diameter of at least 18 inches. In a further related example, Feeder housing 50 may be less than 85 inches tall. In a related example, Feeder housing 50 may be less than 65 inches tall. In a further related example, feeder housing may be 54 inches tall. Feeder housing 50 may be greater than 20 inches tall. In a related example, Feeder housing 50 may be greater than 45 inches tall.

Optionally, the feeder system has a shaped piece of sheet metal between Feed distribution orifice 20 and Automatic feeder 90 which guides the feed out of Feeder housing 10. Optionally, the feeder system has multiple wires across Feed distribution orifice 20 having a wire gauge and spacing sufficient to deter small animals such as squirrels from entering Automatic feeder 90.

### Example 2

The above described feeder system may be secured to the rack of an all-terrain vehicle and transported to a location that is desirable for feeding animals such as deer. After arriving at general area of the feeding location, a location for the feeding system may be identified so that Feed distribution orifice 20 is adjacent to an area which Automatic feeder 90 may spread feed over and which is easily accessible by the desired animals which are to be fed. After identifying the location for placement of the feeder system, Ground anchor rods 100 should be driven into the ground at locations that will be interior to Feeder housing 10. Then, Feeder housing 10 is placed and positioned as previously identified and Anchoring lines 105 are attached to Ground anchor rods 100 followed by the tensioning of Anchoring lines 105 using Anchoring tensioning devices 110 which may be turnbuckles. Work with Anchoring lines 105 is accomplished through Feeder rear access panel 60. After the feeder system is secured in place Feed container 75 with Automatic feeder 90 already attached is lowered through the opening in Feeder housing top 40 until Feed container 75 rests on Feeder support bar 80. Automatic feeder 90 is then rotated until the direction of feed ejection is aligned with Feed distribution orifice 20. Optionally, Feed container 75 and Feed container top 77 may be securely strapped into position by a securing device such as ratchet straps. Such securing may also serve to prevent tampering. After the feeding system is properly set up Feeder rear access panel 60 may be closed and optionally locked.

As that term is used herein “diameter” refers to the diameter of the smallest circle that will completely enclose the base of the relevant Feeder housing 10 when the base of Feeder housing 10 is not circular.

The above-described embodiments have a number independently useful individual features that have particular utility when used in combination with one another including combinations of features from embodiments described separately. There are, of course, other alternate embodiments which are obvious from the foregoing descriptions of the invention, which are intended to be included within the scope of the invention, as defined by the following claims.

I claim:

1. a feeder system comprising:
a. a directional automatic feeder;
b. a feed container positioned above the directional automatic feeder;
c. a cavity below the feed container;
d. a structure surrounding the directional automatic feeder, the feed container, and the cavity;
e. wherein the structure is arranged and configured to be anchored securely to the ground.

2. The feeder system of claim 1 further comprising tension lines arranged and configured to be anchored securely to the ground.

3. The feeder system of claim 1 wherein the structure comprises fiberglass reinforced concrete.

4. The feeder system of claim 1 wherein the structure consists essentially of fiberglass reinforced concrete.

5. The feeder system of claim 1 wherein the structure is camouflaged relative to wooded environments.

6. The feeder system of claim 1 wherein the structure resembles a tree stump.

7. The feeder system of claim 1 wherein the structure resembles a tree stump selected from an oak tree stump, a cypress tree stump, and a pine tree stump.

8. The feeder system of claim 1 wherein the structure resembles a tree stump selected from a hardwood tree stump and a coniferous tree stump.

9. The feeder system of claim 1 wherein the structure has a diameter of greater than 24 inches.
